(19) United States
(12) Patent Application Publication
(10) Pub. No.: US 2023/0145431 A1
(43) Pub. Date: May 11, 2023

(54) SPOOLABLE DEVICE, METHOD FOR MAKING A SPOOLABLE DEVICE, AND SYSTEM

(71) Applicants: Yuh Loh, Cypress, TX (US); Lorn Rendall, Houston, TX (US); John Raggio, Lafayette, LA (US)

(72) Inventors: Yuh Loh, Cypress, TX (US); Lorn Rendall, Houston, TX (US); John Raggio, Lafayette, LA (US)

(73) Assignee: Baker Hughes Oilfield Operations LLC, Houston, TX (US)

(21) Appl. No.: 17/521,345

(22) Filed: Nov. 8, 2021

(51) Int. Cl. E21B 47/01; B65H 75/50

(52) U.S. Cl. CPC E21B 47/01; B65H 75/50; B23K 15/0053

(57) ABSTRACT

A spoolable device including a first communication interface, a second communication interface, a power management module, a functional electrical module, and a junction joining each of the above elements together and creating a shared pressure chamber. A method for making a spoolable device comprising welding a functional electrical module to a first portion of a junction box, welding a first communication interface to the first portion of a junction box, welding a power management module to a second portion of a junction box, welding a second communication interface to the second portion of a junction box, and welding the first portion of a junction box to the second portion of the junction box to form a pressure chamber inside the first and second portions of the junction box.

### BACKGROUND

In the resource recovery and fluid sequestration industries, there is need for signal conduction, sensory, and actuation operations in a downhole environment. One of the operational interests for such activity is the ability to spool a conductor that includes modules for various purposes. The art has struggled with spooling modules that inevitably are relatively long and relatively rigid. Such constructions inherently do not spool well. The art would therefore well receive alternatives that improve spoolability of modules that are needed in the downhole environment.

### SUMMARY

An embodiment of a spoolable device including a first communication interface, a second communication interface, a power management module, a functional electrical module, and a junction joining each of the above elements together and creating a shared pressure chamber.

An embodiment of a method for making a spoolable device comprising welding a functional electrical module to a first portion of a junction box, welding a first communication interface to the first portion of a junction box, welding a power management module to a second portion of a junction box, welding a second communication interface to the second portion of a junction box, and welding the first portion of a junction box to the second portion of the junction box to form a pressure chamber inside the first and second portions of the junction box.

A borehole system including a borehole in a subsurface formation, a string in the borehole, and a device disposed within or as a part of the string.

### BRIEF DESCRIPTION OF THE DRAWINGS

The following descriptions should not be considered limiting in any way. With reference to the accompanying drawings, like elements are numbered alike:

FIG. 1 is a schematic view of a spoolable device as disclosed herein;

FIGS. 2-9 illustrate a sequence related to the making of the spoolable device; and

FIG. 10 is a schematic view of a borehole system employing the spoolable device as disclosed herein.

### DETAILED DESCRIPTION

A detailed description of one or more embodiments of the disclosed apparatus and method are presented herein by way of exemplification and not limitation with reference to the Figures.

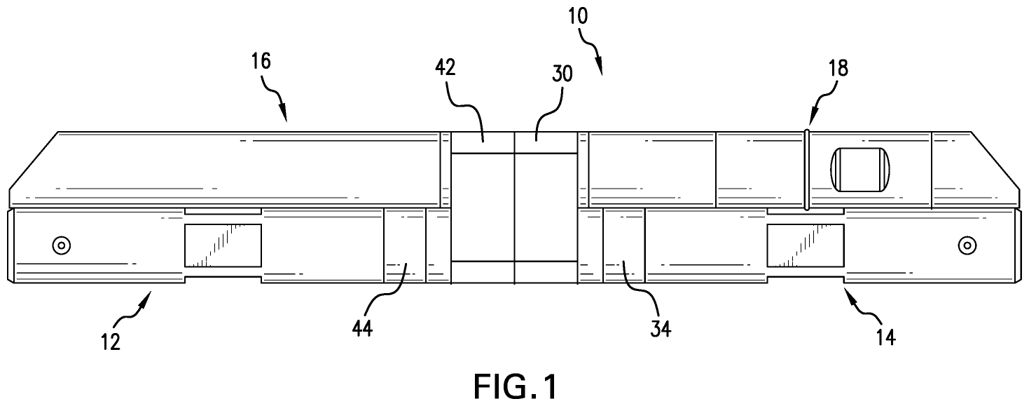

Referring to FIG. 1, a spoolable device 10 is illustrated. The device 10 includes an uphole communications interface 12, a downhole communications interface 14, a power management module 16, and a functional electrical module 18 (e.g., a sensor, actuator, splice module, etc.). Each of the components 12, 14, 16, 18 are joined together via a junction box (made up of two junction box halves 30 and 42) that becomes a pressure housing for all of the components. Individual pressure housings are omitted in the construction as disclosed and length and girth of the device 10 are reduced relative to existing prior art devices of similar function. Because the components effectively share the same space at a junction thereof, the device 10 is robust and yet of smaller form factor. As will be appreciated by one of ordinary skill in the art, a smaller form factor is highly advantageous for a spoolable device since the device when spooled will define a tangent to the spool and the conductors entering and exiting the device will need to experience relatively larger bending angles to come back to the spool. The shorter a device is, the less the angularity for the conductor while spooled. Lesser angularity at ends of the connector reduces failures of the spool and increases spooling density, which reduces footprint, both of which are clearly beneficial to the art. The device 10 is welded together even while sensitive electronics are present inside.

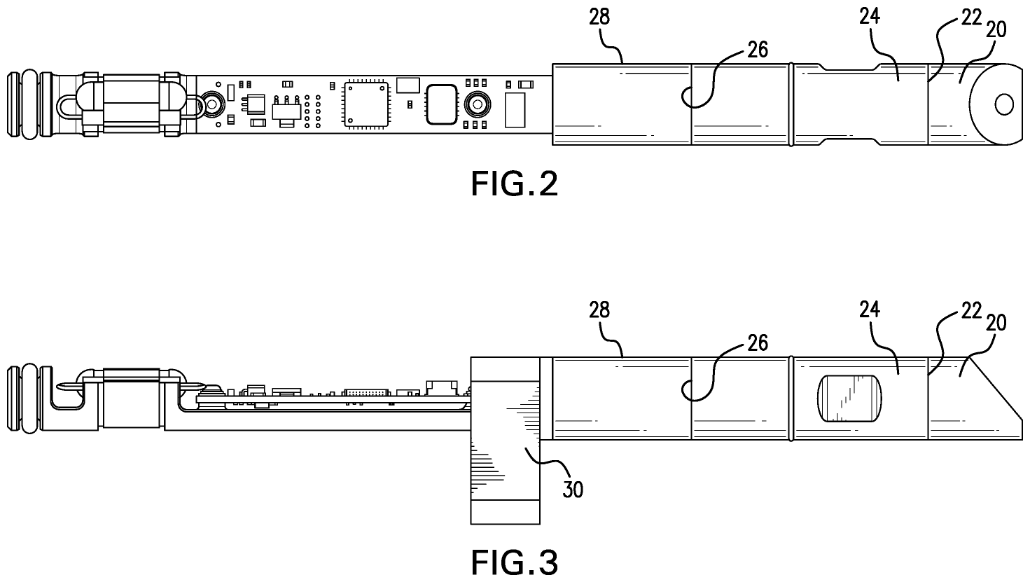

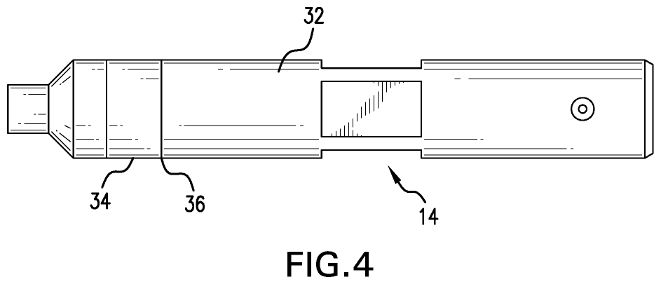

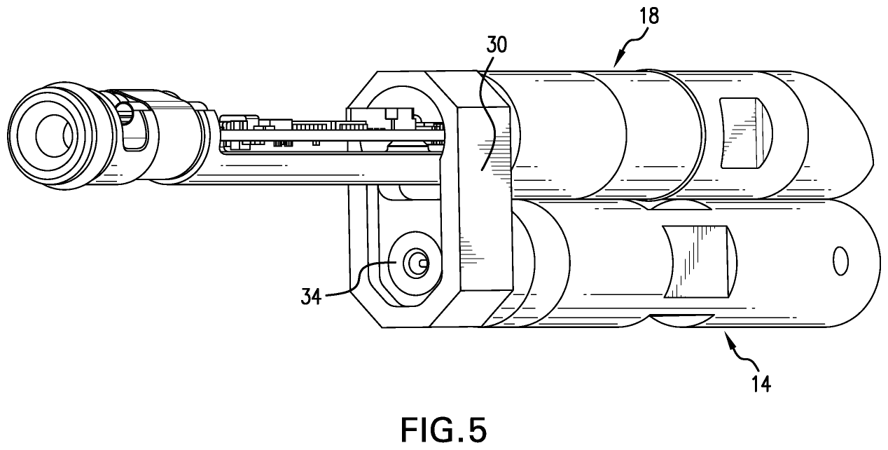

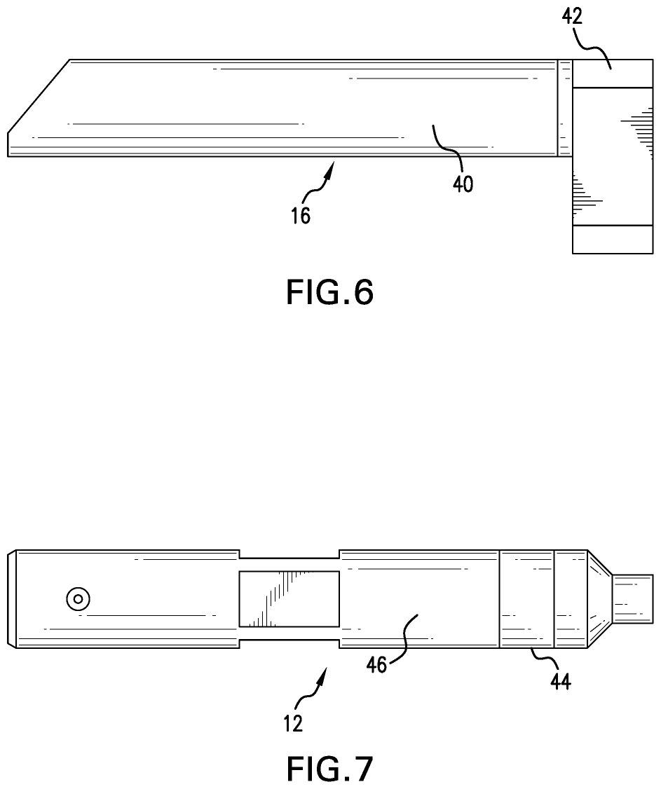

The device 10 is made in the following sequence. Referring to FIGS. 2-9, the functional electrical module is constructed by rotary welding an adapter 20 to one end 22 of a function element 24, which may be a transducer, other type of sensor, actuator, etc. At a second end 26 of the element 24, another rotary weld is placed to join the element 24 with a junction box adapter 28. In FIG. 3, the components of FIG. 2, through junction box adapter 28, are joined with a junction box 30, again, in an embodiment, by rotary welding. Referring to FIGS. 3 and 4 simultaneously one half of the device 10 is completed by welding a feedthrough 32 of communications interface 14 to a junction box adapter 34 at joint 36 by, for example, rotary welding. Once the adapter 34 is welded to the feedthrough 32, the interface 14 may be joined to the junction box 30, by, for example, rotary welding. The condition of the build at this point is seen in FIG. 5 where it is also illustrated that a face welding operation is undertaken to weld the adapter 34 to the junction box 30.

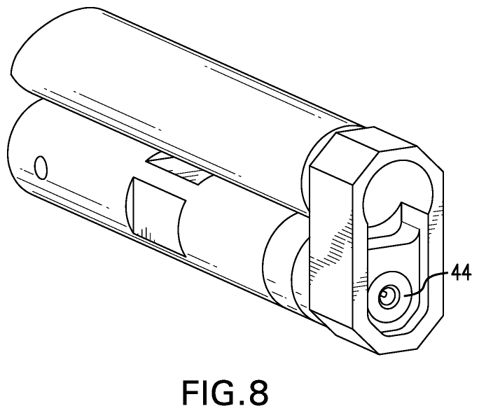

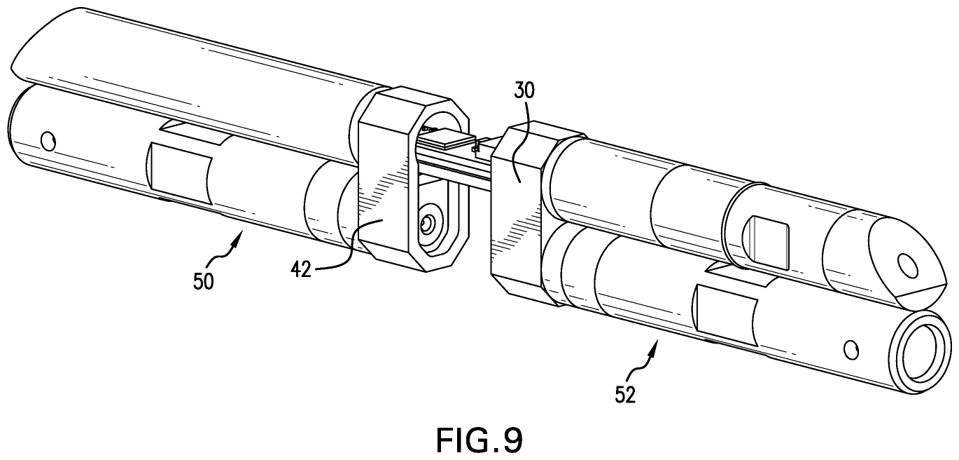

Following the foregoing, another half of the device 10 is constructed in a similar manner. A junction box adapter 40 that will be a part of the interface 12 is welded to junction box 42 in another rotary process for example. A junction box adapter 44 is welded to a cable head 46 in FIG. 7 to create interface 12, which is then rotary welded to junction box 42. In this condition, referring to FIG. 8, the junction box adapter 44 is face welded to the junction box 42. Referring to FIG. 9, two subassemblies 50 and 52 are joined together including internal electronics extending through the junction and then rotary welded to form the device 10 illustrated in FIG. 1. As completed, the device 10 is a pressure vessel in one piece not requiring individual seals but rather sharing the pressure chamber produced.

Various welding processes mentioned herein include rotary welding or face welding and may employ an electron beam process, a laser weld process or other fusing process that is capable of controlling heat affected zone such that internal electronic components are not damaged. Further, it is contemplated that all description of “welding” may be substituted, in embodiments, by alternate means of bonding, whether chemical or mechanical providing a pressure vessel is created and electronics therein are not damaged. In such a way, the benefit of this disclosure, superior spoolability, may still be reaped. Further, it is to be appreciated that while only one device 10 is illustrated, more than one is contemplated on a conductor. Signals being borne by a conductor may be passed through one or more devices 10. A plurality of devices 10 may be disposed along a conductor evenly or unevenly as is desired and practicable for the end purpose of each device 10. For example, perhaps one device 10 will connect to a first type of actuator for a packer for example, while a second device 10 might connect to a valve, etc.

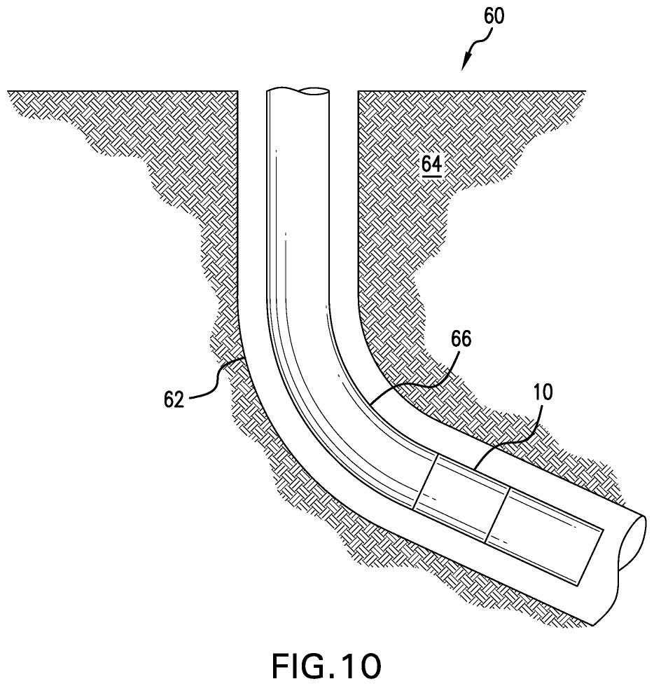

Referring to FIG. 10, a borehole system 60 is illustrated. The system 60 comprises a borehole 62 in a subsurface formation 64. A string 66 is disposed in the borehole 62 and a device 10 is disposed within or as a part of the string 66.

Set forth below are some embodiments of the foregoing disclosure:

Embodiment 1: A spoolable device including a first communication interface, a second communication interface, a power management module, a functional electrical module, and a junction joining each of the above elements together and creating a shared pressure chamber.

Embodiment 2: The device as in any prior embodiment wherein the functional electrical element is a sensor.

Embodiment 3: The device as in any prior embodiment wherein the functional electrical element is an actuator.

Embodiment 4: A method for making a spoolable device comprising welding a functional electrical module to a first portion of a junction box, welding a first communication interface to the first portion of a junction box, welding a power management module to a second portion of a junction box, welding a second communication interface to the second portion of a junction box, and welding the first portion of a junction box to the second portion of the junction box to form a pressure chamber inside the first and second portions of the junction box.

Embodiment 5: The method as in any prior embodiment wherein the welding the functional electrical module to the first portion of the junction box further includes welding an adapter to the element at one end of the element and welding a junction box adapter to an opposite end of the element.

Embodiment 6: The method as in any prior embodiment wherein the welding the first or second communication interface includes welding a junction box adapter to a feedthrough.

Embodiment 7: The method as in any prior embodiment wherein the welding includes rotary welding.

Embodiment 8: The method as in any prior embodiment wherein the welding further includes face welding.

Embodiment 9: The method as in any prior embodiment wherein the welding is electron beam welding.

Embodiment 10: A borehole system including a borehole in a subsurface formation, a string in the borehole, and a device as in any prior embodiment disposed within or as a part of the string.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% or 5%, or 2% of a given value.

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A spoolable device comprising:
a first communication interface;
a second communication interface;
a power management module;
a functional electrical module; and
a junction joining each of the above elements together and creating a shared pressure chamber.

2. The device as claimed in claim 1 wherein the functional electrical element is a sensor.

3. The device as claimed in claim 1 wherein the functional electrical element is an actuator.

4. A method for making a spoolable device comprising:
welding a functional electrical module to a first portion of a junction box;
welding a first communication interface to the first portion of a junction box;
welding a power management module to a second portion of a junction box;
welding a second communication interface to the second portion of a junction box; and
welding the first portion of a junction box to the second portion of the junction box to form a pressure chamber inside the first and second portions of the junction box.

5. The method as claimed in claim 4 wherein the welding the functional electrical module to the first portion of the junction box further includes welding an adapter to the element at one end of the element and welding a junction box adapter to an opposite end of the element.

6. The method as claimed in claim 4 wherein the welding the first or second communication interface includes welding a junction box adapter to a feedthrough.

7. The method as claimed in claim 4 wherein the welding includes rotary welding.

8. The method as claimed in claim 7 wherein the welding further includes face welding.

9. The method as claimed in claim 4 wherein the welding is electron beam welding.

10. A borehole system comprising:
a borehole in a subsurface formation;
a string in the borehole; and
a device as claimed in claim 1 disposed within or as a part of the string.
